(19) United States
(12) Patent Application Publication
(10) Pub. No.: US 2026/0316415 A1
(43) Pub. Date: Oct. 15, 2026

(54) PRESS FRAME AND ATTACHMENTS

(71) Applicant: Snap-on Incorporated, Kenosha, WI (US)

(72) Inventors: Allen M. Hutchison, Beach Park, IL (US); Nicholas A. Gabbey, Kenosha, WI (US); George R.R. Call, Kenosha, WI (US)

(73) Assignee: Snap-on Incorporated, Kenosha, WI (US)

(21) Appl. No.: 19/565,327

(22) Filed: Mar. 12, 2026

Related U.S. Application Data
(60) Provisional application No. 63/787,277, filed on Apr. 11, 2025.

(51) Int. Cl. B30B 15/04; B30B 15/08

(52) U.S. Cl. CPC B30B 15/04; B30B 15/08

(57) ABSTRACT

A press frame for manipulating a workpiece is provided. The press frame includes a frame having a first upright and a second upright, a cross member extending between the first upright and the second upright, and a bed frame positioned below the cross member, wherein the bed frame extends between the first upright and the second upright. The press frame further includes a workpiece support system including a support arm coupled to the frame and configured to rotate outward in a rotated position, and a coupler extending between the support arm and a workpiece. The coupler is configured to engage the workpiece to facilitate suspending the workpiece.

### CROSS-REFERENCE TO RELATED APPLICATION(S)

This application claims the benefit of U.S. Provisional Application No. 63/787,277 entitled, “Press Frame and Attachments,” filed on Apr. 11, 2025, the entire contents of which are hereby incorporated.

### BACKGROUND

A press frame or shop press applies force to shape, assemble, or modify materials, such as a workpiece. When long workpieces, such as drive shafts or control arms, are to be manipulated by the press frame, the operator of the press frame may have difficulty properly placing and holding the workpiece in an optimal position with respect to the press frame due to the overall length of the workpiece. The operator may find it challenging to simultaneously support the workpiece, position and hold various components of the press frame, and operate the hydraulic pump of the press frame. Thus, the operator may employ the assistance of a second operator; however, this may be inefficient and/or impact the safety of one or both operators.

Moreover, some press frames may lack convenient and precise adjustability of its bed frame. Many bed frames are heavy and therefore are challenging to adjust into an optimal operating position. Operating the press frame in a less than optimal operating position may put excess strain on the operator. Therefore, some workshops use standalone height adjustable equipment (e.g., a cable pulley system, a separate hydraulic lift system, or a jack system such as floor jacks or tractor hi-lift jacks), when available, to assist the operator in adjusting the bed frame; however, using standalone equipment may produce unstable conditions since the standalone equipment is not mechanically connected to the press frame.

Further, some press frames may lack dedicated storage for storing press frame tooling or excess parts. Many times operators improperly store the press frame tools, such as throwing the tools in a bin or box, which may cause the tools to be lost or misplaced and results in inefficient workflow.

### SUMMARY

Embodiments of the disclosure relate to a press frame (e.g., hydraulic press frame) or shop press. The press frame may include a workpiece support system including a support arm and a coupler to suspend a workpiece without an operator holding the workpiece. Further, the press frame herein may improve the adjustability of its bed frame through the use of at least one (e.g., gas) strut (e.g., adjuster) for raising and/or lowering the bed frame, and the press frame may provide storage of press frame tools to provide the operator with easy access to the tools and minimize lost or misplaced tools.

In one embodiment, a press frame for manipulating a workpiece is provided. The press frame includes a frame having a first upright and a second upright, a cross member extending between the first upright and the second upright, and a bed frame positioned below the cross member, wherein the bed frame extends between the first upright and the second upright. The press frame further includes a workpiece support system including a support arm coupled to the frame and configured to rotate outward in a rotated position, and a coupler extending between the support arm and a workpiece. The coupler of the workpiece support system is configured to engage the workpiece to facilitate suspending the workpiece.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1 is an isometric view of a press frame with a bed frame with an adjuster and attachments including a workpiece support system and a tool storage system, according to an example embodiment.

FIG. 2 is an additional isometric view of a support arm of the workpiece support system of FIG. 1, without the tool storage system and the support arm in a disengaged position.

FIG. 3 is a partial isometric view of the support arm of FIG. 2, with the support arm in an engaged position.

FIG. 4 is another isometric view of the press frame of FIG. 1.

FIG. 5 is a partial isometric view of the press frame of FIG. 4, where a coupler and an engager of the workpiece support system are shown suspending a workpiece.

FIG. 6 is a partial isometric view of the tool storage system coupled to the press frame of FIG. 1.

FIG. 7A is a partial isometric view of a left strut of the press frame of FIG. 1.

FIG. 7B is a partial isometric view of a right strut of the press frame of FIG. 1.

### DETAILED DESCRIPTION

This description provides several example embodiments, at least some of which pertain to a press frame including an adjustable bed frame, a workpiece support system, and a tool set holder (e.g., tool storage system), with the press frame at and/or near a service center or work shop.

Embodiments of the press frame for manipulating a workpiece are provided. The press frame includes a frame having a first upright and a second upright, a cross member extending between the first upright and the second upright, and an adjustable bed frame positioned below the cross member, wherein the bed frame extends between the first upright and the second upright. The press frame further includes a workpiece support system including a support arm coupled to the frame and configured to rotate outward in a rotated position, and a coupler extending between the support arm and a workpiece. The coupler of the workpiece support system includes an attachment configured to facilitate suspending the workpiece. The press frame may also include a tool storage system.

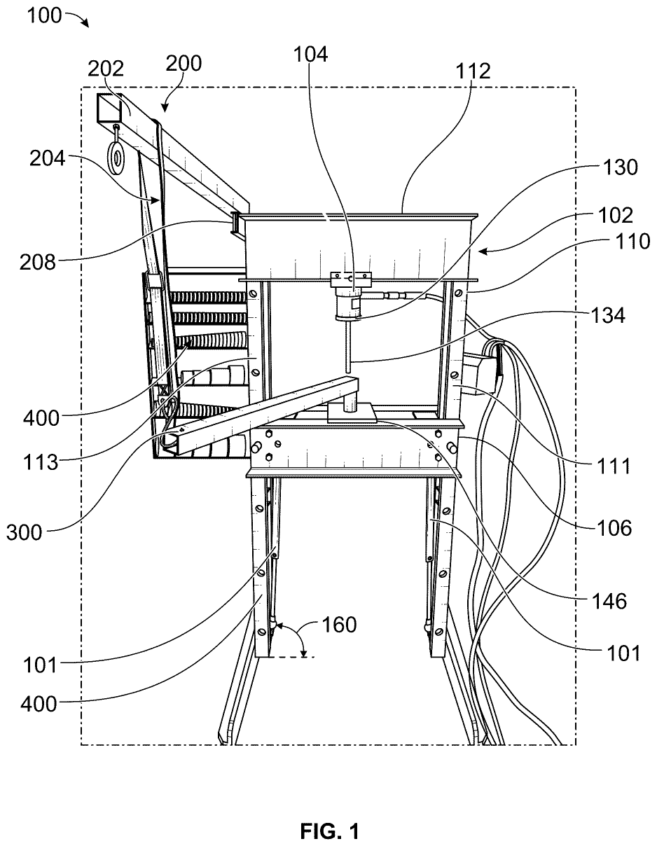

FIG. 1 illustrates a press frame 100, according to an example embodiment. The press frame 100 may be provided in a work shop to manipulate at least one (e.g., metal) workpiece 300, such as a drive shaft or a control arm.

The press frame 100 may include at least one adjuster 101 and a plurality attachments, such as a workpiece support system 200 to support the workpiece 300 and a tool storage system 400 to store one or more press frame tools.

In some example embodiments, the press frame 100 may include a frame 102, a hydraulic ram 104, and a bed frame 106, wherein the at least one adjuster 101 is configured to smoothly (e.g., provide mechanical assistance) adjust the height of the bed frame 106 within the frame 102.

The frame 102 may include at least two uprights 110 (e.g., a first or right upright 111 and a second or left upright 113) to provide structural support to the frame 102, with at least one upper cross member 112 extending between (e.g., connecting) the uprights 110 to provide stability to the press frame 100. Moreover, the right upright 111 may include a right upright channel 118 formed therein and the left upright 113 may include a left upright channel 120 formed therein, wherein the bed frame 106 may be configured to vertically translate within the upright channels 118 and 120.

The frame 102 further may include a pair of base legs 119 to provide further support, alignment, and stability to the frame 102, wherein the base legs 119 may be substantially perpendicular to the uprights 110. Moreover, at least one support 122 may be coupled between at least one upright 110 and at least one base leg of the pair of base legs 119 to reinforce the base of the press frame 100 and minimize deflection during the operation of the press frame 100.

The bed frame 106 may include an upper surface and a lower surface to provide a stable (e.g., substantially horizontal) platform for supporting the workpiece 300 and absorbing forces exerted during pressing operations. The bed frame 106 may include at least one arbor plate 146 coupled to the upper surface of the bed frame 106. In an example embodiment, the arbor plate 146 may be positioned substantially equidistant from the right upright 111 and the left upright 113 and may serve as a contact point for the workpiece 300 during the pressing operation to distribute force (e.g., substantially) evenly to the workpiece 300 and prevent damage to the workpiece 300 and/or the press frame 100. The arbor plate 146 may be provided as a pair of arbor plates, wherein each arbor plate of the pair of arbor plates is configured to support and/or abut the workpiece 300. The arbor plate 146 may be provided in any suitable shape and/or size.

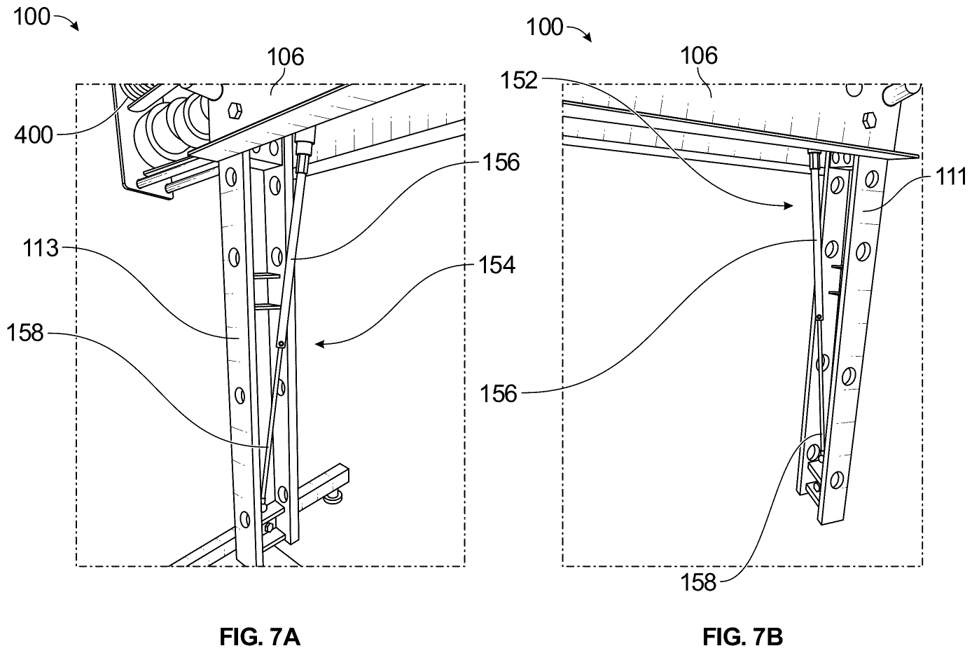

A position of the bed frame 106 may be adjusted by the at least one adjuster 101 (as shown best in FIGS. 1, 7A, and 7B) to modify the working height of the bed frame 106 to accommodate varying sizes and shapes of the workpiece 300 and reduce potential strain on an operator. The bed frame 106 may be raised or lowered (e.g., vertically adjusted) within the upright channels 118 and 120 through use of the adjuster 101. Further, the upright channels 118 and 120 are configured to limit the transverse (e.g., horizontal) movement of the bed frame 106 during operation of the press frame 100.

In an example embodiment, the frame 102, the bed frame 106, the upper cross member 112, the base legs 119, the support 122, and/or the arbor plate 146 may be provided in the form of a metal, such as steel, and may be coupled together through welding, bolting, cast construction, a combination thereof and/or the like to provide durability and resistance to bending under a load. The frame 102 may include additional reinforcements, such as gussets or additional crossbars, to provide additional rigidity and reduce deflection during high-force applications.

Continuing with FIG. 1, the press frame 100 also may include the hydraulic ram 104 configured to generate force for performing pressing operations on the workpiece 300. The hydraulic ram 104 may be coupled to the upper cross member 112 with a fastener, such as a bracket, discussed herein.

The hydraulic ram 104 may operate using hydraulic pressure, and the hydraulic pressure may be generated by (e.g., manually) pumping a hydraulic pump handle coupled to and extending from the hydraulic ram 104. In other embodiments, the hydraulic pressure may be applied through a (e.g., foot) pedal (e.g., to be stepped on/controlled by the operator) or the like, in communication with the hydraulic ram 104. The pumping action, via the handle or the pedal, may force hydraulic fluid through a (e.g., one-way) valve to increase pressure inside a chamber of the hydraulic rams 104 piston chamber and to extend a ram 134 downward to apply force on the workpiece 300. In other embodiments, the hydraulic pump handle may be automatically operated, rather than manually operated through use of a hydraulic system (e.g., a motorized hydraulic pump, a power source, and/or compressed air), pneumatic system, and/or electric system (e.g., an electric motor and gear system).

Turning to FIGS. 1, 7A, and 7B, in addition to the hydraulic ram 104, the press frame 100 may include the adjuster 101 to (e.g., automatically) adjust, guide, and control at least one component (e.g., the bed frame 106) of the press frame 100. In an example embodiment, the adjuster 101 may be coupled between the bed frame 106 and at least one of the uprights 110 and/or the base leg 119 to facilitate adjusting the height of the bed frame 106 before, during, and/or after the operation of the press frame 100. Adjusting the bed frame 106 via the adjuster 101 provides an operator with the capability of placing the bed frame 106 in an optimal operating position based on the size and shape of the workpiece 300. Thus, the adjuster 101 may support the weight of the bed to prevent the operator from having to support the weight of the bed frame 106 while adjusting the height.

The adjuster 101 of the press frame 100 may include at least one pair of struts 150 (e.g., a right strut 152 (as best shown in FIG. 7B) and a left strut 154 (as best shown in FIG. 7A)) located between the uprights 110 and (e.g., a lower surface of) the bed frame 106, and facilitate controlled height adjustment of the bed frame 106. Although two struts are shown in FIGS. 1, 7A, and 7B, any suitable number of struts 150 may be coupled between the uprights 110 of the frame 102 and the bed frame 106 to facilitate stability and movement of the bed frame 106.

In an example embodiment, each strut 152 and 154 of the pair of struts 150 may include a strut housing 156 and an extension arm 158 extending from (e.g., and/or telescoping with) the strut housing 156. The strut housing 156 may be coupled to at least one of the uprights 110 at or near the base leg 119 and the extension arm 158 may be coupled to (e.g., the lower surface of) the bed frame 106, to provide stability for the bed frame 106 while providing for substantially smooth (e.g., height) adjustments. In an example embodiment, the strut housing 156 of the struts 150 may form an angle 160 with the ground and/or the base leg 119. The angle 160 may be an acute angle, wherein the angle 160 is between about 20 degrees and about 88 degrees, or between about 35 degrees and about 85 degrees, or about 80 degrees. In an example embodiment, the struts 150 further may include hinges and/or reinforcement elements such as cross-braces, which facilitate load distribution and may prevent excessive flexing under heavy loads.

In an example embodiment, the struts 150 are gas struts and may include (e.g., hydraulic or pneumatic) cylinders that use compressed gas to exert force to adjust the height of the bed frame 106.

Although in embodiments described above adjuster 101 includes gas struts 150, in other embodiments the adjuster 101 may include other suitable adjusters or adjusting equipment to modify and/or adjust the height of the bed frame 106 of the press frame 100, such as hydraulic struts, mechanical spring struts, elastic cord or bungee cord, pneumatic springs, viscoelastic dampers, linear actuators (e.g., electric), torsion springs, counterbalance systems (e.g., weights and pulleys), friction dampers, and/or a combination thereof.

The struts 150 may be operated (e.g., by the operator) via a (e.g., foot) pedal or another actuator or controller. The operation of the gas struts 150 may be independent from the operation of the hydraulic ram 104. Further, in other embodiments, the bed frame 106 may be adjusted manually in addition to or as an alternative to using the adjuster 101.

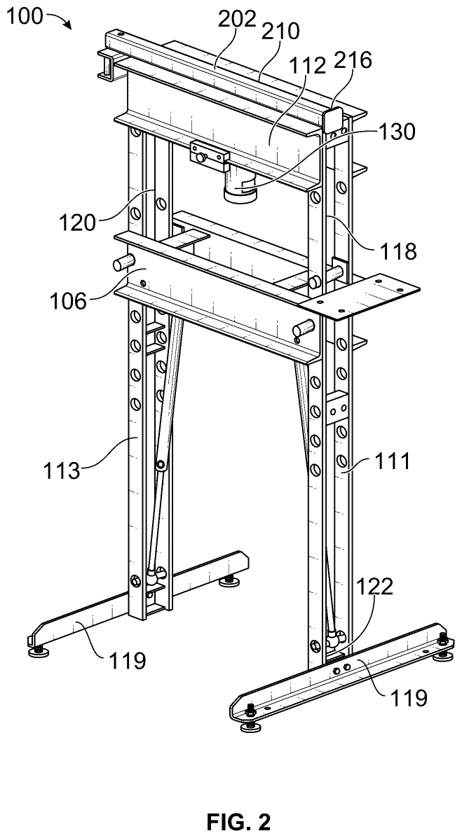

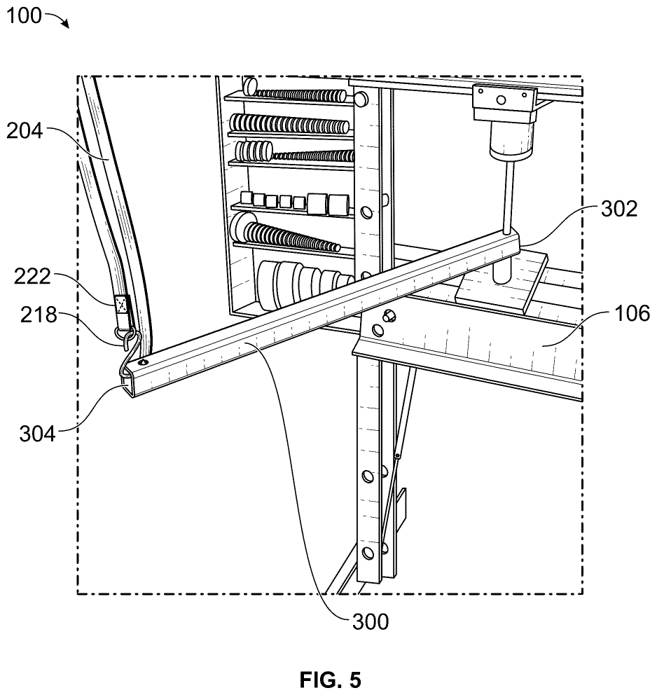

Turning to FIGS. 2-5, in addition to the adjuster 101, the press frame 100 may include at least one workpiece support system 200 to support at least one workpiece 300 before, during, and/or after operation of the press frame 100. The workpiece support system 200 may eliminate and/or minimize intervention from an operator to hold the workpiece 300 during manipulation of the workpiece 300 and/or during operation of the press frame 100.

In an example embodiment, the workpiece support system 200 may include at least one support arm 202 and at least one coupler 204 configured to engage and/or suspend the workpiece 300. For example, one end 302 of the workpiece 300 may be positioned between the hydraulic ram 104 and the arbor plate 146 positioned on the bed frame 106, and the other (e.g., opposing) end 304 of the workpiece 300 may be coupled to (e.g., supported and/or suspended by) the coupler 204. In an example embodiment, when the workpiece 300 is supported by the workpiece support system 200, the workpiece 300 may be substantially parallel to the ground and/or the bed frame 106.

As shown in at least FIGS. 1-4, the support arm 202 may be coupled to at least one of the uprights 110, the upper cross member 112, and/or the bed frame 106 of the press frame 100.

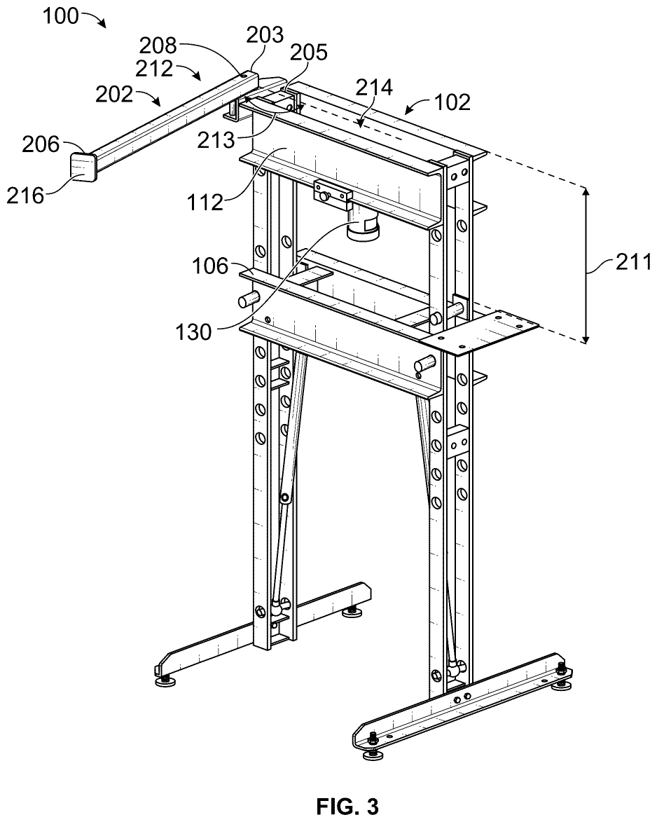

As shown in FIG. 3, the support arm 202 is (e.g., removably) coupled to the upper cross member 112 with a bracket 205. The bracket 205 is configured to enable an existing press frame to be retrofit with the workpiece support system 200. In other example embodiments, the support arm 202 may not use the bracket 205 and may be directly coupled to at least one of the uprights 110, the upper cross member 112, and/or the bed frame 106.

In an example embodiment, the support arm 202 has a first end 203 and an opposing second end 206, and the support arm 202 may have a length that is longer than a length of the upper cross member 112. For example, the length of the support arm 202 is substantially equivalent to the length of the upper cross member 112 plus the length of the bracket 205. In other embodiments, the support arm 202 has any suitable length.

Continuing with FIGS. 2 and 3, in an example embodiment, the first end 203 of the support arm 202 may be coupled to (e.g., the left upright 113 or the channel 120 of) the frame 102 via the bracket 205 and/or a hinge 208, and the second end 206 may be configured to swing outward or away from the frame 102. The hinge 208 may be configured to facilitate rotating the support arm 202 between a disengaged (e.g., non-rotated) position 210, as shown in FIG. 2, and an engaged (e.g., rotated) position 212, as shown in FIG. 3, to accommodate workpieces of varying sizes and shapes. In the disengaged position 210, the support arm 202 may not support the workpiece 300. Comparatively, in the engaged position 212, the support arm 202 may facilitate supporting and/or suspending the workpiece 300.

During operation, in an example embodiment, the support arm 202 is rotated from the position 210 via the hinge 208 a distance outward (e.g., away) from the upper cross member 112 to the engaged position 212. The support arm 202 may form an (e.g., acute) angle 213 with respect to a channel 214 formed in the top of the upper cross member 112. In an example embodiment, the support arm 202 may rotate between about 0 degrees and about 90 degrees (e.g., in either direction, such as a forward direction) from the channel 214. In the disengaged position 210, the angle 213 may be about 0 degrees. In comparison, when the support arm 202 is in the engaged position 212, the angle 213 may be about 45 degrees. The angle 213 between the support arm 202 and the channel 214 may be determined (e.g., by the operator) based on the size and the shape of the workpiece 300. For example, a long or wide workpiece 300 may specify a larger angle as compared to a small or narrow workpiece 300 which may specify a smaller angle. Additionally, the angle 213 formed between the support arm 202 and the channel 214 of the upper cross member 112 may be any suitable angle, including an obtuse angle in some example embodiments.

Once the support arm 202 reaches the rotated position 212, the support arm 202 may be locked in place with a pin, a limiter, a lock, or other suitable locks. The pin may prevent the support arm 202 from further rotation during operation of the press frame 100.

In other example embodiments, the support arm 202 may be provided at a substantially fixed angle 113, such as at about 45 degrees, with respect to the channel 214 of the upper cross member 112. In such an example embodiment with a substantially fixed angle, the support arm 202 may not be configured to rotate.

Moreover, in other example embodiments, a limiter may be provided on either side of the support arm 202 to limit the angle of rotation of the support arm. For example, the limiter may limit the support arm 202 from rotating between about 0 degrees and about 45 degrees. In other words, the limiter may prevent the support arm 202 from extending past a specified angle of rotation.

In an example embodiment, the support arm 202 may be provided in the form of a metal, such as steel or another suitable material. Moreover, the support arm 202 may be retractable or collapsible. For example, the support arm 202 may include multiple tubes to shorten or lengthen the overall size of the support arm 202. In some embodiments, the tubes may be telescoping.

Further, the support arm 202 may have any suitable cross-sectional shape, such as round or rectangular. For example, although the support arm 202 is shown in the figures with a substantially rectangular cross-section, the support arm 202 may be a tube with a round cross-section.

The support arm 202 may also include a flange 216 (as shown in FIG. 3) at or near the second end 203 of the support arm 202. The flange 216 may prevent the coupler 204 from disengaging and/or sliding off (e.g., the second end 203) of the support arm 202. In an example embodiment, the flange 216 has a shape substantially the same as the cross-sectional shape of the support arm 202, and the flange 216 is configured to have a cross-sectional size that is larger than the cross-sectional size of the support arm 202 (e.g., such that the flange 216 extends beyond the periphery of the support arm 202).

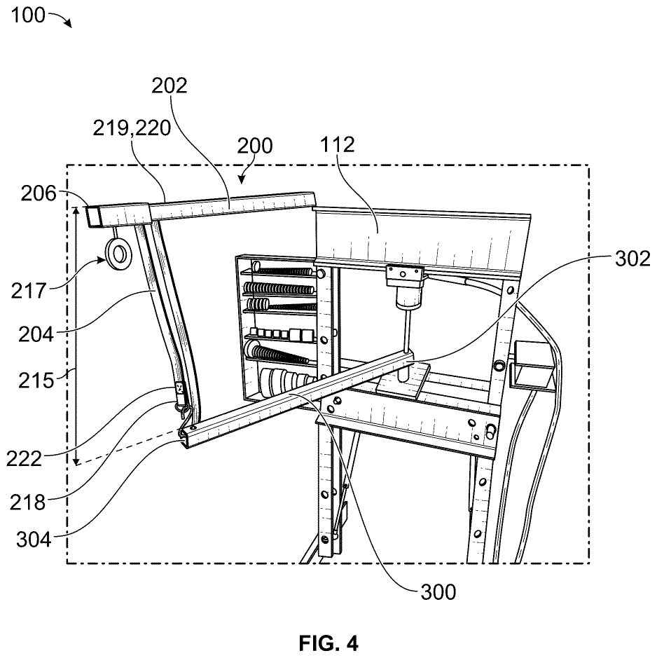

Moreover, the support arm 202 may include a stop 217 (as best shown in FIG. 4), such as a hook or a screw, positioned at any point along (e.g., a bottom surface of) the length of the support arm 202, such as at or near the end 206 of the support arm 202. In some embodiments, the stop 217 is a mechanical stop. For example, the stop 217 may be coupled to a top surface or a bottom surface of the support arm 202. The stop 217 may be configured to engage the coupler 204 to prevent the coupler 204 from disengaging or sliding off the support arm 202. In other example embodiments, the (e.g., mechanical) stop 217 may replace the flange 216 (e.g., at or near the second end 203 of the support arm 202).

In addition to the support arm 202, the frame 102 of the press frame 100 may include a second support arm coupled to the bed frame 106 to work in conjunction with the support arm 202. Alternatively, the second support arm may be coupled to the bed frame 106, replacing the support arm 202. In this alternative embodiment, the frame 102 does not include the support arm 202 but rather only includes the second support arm, which may be similar in form and function to the support arm 202. In example embodiments that include the second support arm, the second support arm may provide support from underneath the workpiece 300, whereas the support arm 202 may offer support from above the workpiece 300.

Turning to the coupler 204, the coupler 204 may be configured to slide along the support arm 202 and be selectively positioned (e.g., by the operator) at an attachment point 219, wherein the attachment point 219 may be selected based on the size and shape of the workpiece 300. For example, the operator may easily slide (e.g., transition) the coupler 204 from a first position for a first workpiece of a first size (e.g., large) to a second position for a second workpiece of a second size (e.g., small) easily and in a relatively short amount of time. The selective positioning of the coupler 204 provides flexibility in accommodating varying workpieces. In other embodiments, the coupler 204 is provided at a substantially fixed position, via a fastener or similar, at or near the attachment point 219 along the support arm 202.

In an example embodiment, the coupler 204 may have a length 215 (as best shown in FIG. 4) provided between a first end 220 positioned at or near the attachment point 219 along the support arm 202 and an opposing second end 222 (e.g., configured to engage the workpiece 300). The coupler 204 may be coupled to, wrapped around, or extend from the support arm 202 to the workpiece 300. For example, the coupler 204 may be a strap, a chain, a cable, a rope, and/or the like, that may have flexibility and/or stretchability to absorb stress during operation of the press frame 100 without (e.g., permanently) deforming or breaking. The coupler 204 may be provided in the form of a woven fabric, such as a nylon, polyester, canvas, leather, or a combination thereof, although other materials may be suitable.

The length 215 of the coupler 204 may be adjusted (e.g., lengthened or shortened) to accommodate varying sizes and shapes of the workpiece 300. For example, the coupler 204 may include a ratchet clip (e.g., for the operator) to easily adjust the length 215 of the coupler 204.

Moreover, the coupler 204 further may be adjusted to accommodate the varying height of the bed frame 106. In an example embodiment, the length 215 of the coupler 204 may be substantially the same as a distance 211 provided between (e.g., a top surface of) the upper cross member 112 and (e.g., a top surface of) the bed frame 106. Thus, when the distance 211 is adjusted by (e.g., the vertical) movement of the bed frame 106, the length 215 of the coupler 204 may be adjusted.

In an example embodiment, the coupler 204, in use, may be substantially parallel to at least one of the uprights 110 and further may be substantially perpendicular to the support arm 202 and/or the workpiece 300. In other embodiments, the coupler 204 may be adaptable and may be provided at an (e.g., acute) angle with respect to at least one of the uprights 110.

Furthermore, as shown, the coupler 204 may include an (e.g., optional) engager 218, such as a hook, at or near the second end 222 of the coupler 204 for engaging (e.g., at least one end of) the workpiece 300. The engager 218 is configured to be inserted into an open end of the workpiece 300 or into an opening formed within the workpiece 300. Once the engager 218 is coupled to the workpiece 300, the workpiece 300 is substantially secured and/or suspended by the coupler 204 so that an operator does not hold the workpiece 300 before, during, and/or after operation of the press frame 100. When the workpiece 300 is secured and/or suspended, the workpiece 300 may be substantially parallel to the ground.

In other example embodiments, the coupler 204 does not include the engager 218. In this case, the workpiece 300 is configured to (e.g., directly) engage the coupler 204 (e.g., at or near the second end 222). For example, when the coupler 204 is a rope, the rope may create a loop around the support arm 202 such that the workpiece 300 may be inserted (e.g., directly) into the (e.g., bottom of the) loop.

Moreover, in other example embodiments, any suitable number of support arms 202, couplers 204, and/or engagers 218 may be used to facilitate suspending and/or retaining the workpiece 300 with respect to the press frame 100.

Continuing with FIG. 1, in addition to the workpiece support system 200, the tool storage system 400 is coupled to the frame 102 of the press frame 100 to organize, store, and secure tools used with the press frame 100 to maximize efficiency, visibility, and accessibility for the operator. The tool storage system 400 may be positioned to prevent interference with the operation of the press frame 100. In an example embodiment, the tool storage system 400 may include a housing 402 and a plurality of shelves 404 to store the press frame tools.

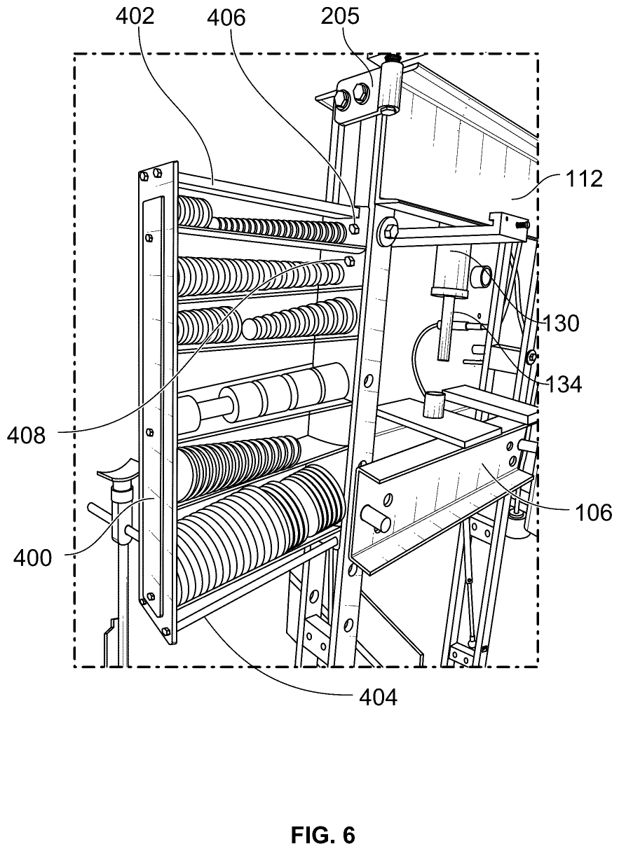

As shown in at least FIGS. 1 and 6, the housing 402 may be coupled to the frame 102, along at least one of the uprights 110. In an example embodiment, the housing 402 may have a substantially rectangular shape with a height and a width, wherein the width of the housing 402 may be substantially the same width as at least one of the uprights 110 and the height of the housing 402 may be substantially equal to or less than a height provided between (e.g., a lower surface of) the upper cross member 112 and (e.g., a lower surface of) the bed frame 106. The housing 402 may be provided in other suitable shapes and sizes.

As shown in at least FIGS. 1 and 6, the housing 402 of the tool storage system 400 may include a plurality of openings, along at least one side 406, configured to receive at least one fastener 408, such as a screw or similar, therein to facilitate coupling the housing 402 to the frame 102. In an example embodiment, the housing 402 of the tool storage system 400 is removably and/or fixedly coupled to the frame 102. In other embodiments, the housing 402 is rotatably coupled to the frame 102 with a coupler, such as a hinge to facilitate rotation.

In an example embodiment, the shelves 404 may be adjustable and/or may be provided at different heights and/or different widths within the housing 402 to accommodate press frame tools of varying sizes. In other example embodiments, the tool storage system 400 may, additionally or alternatively, include drawers within the housing 402. Further, the tool storage system 400 may have a modular design for customization and expansion of the system 400.

Moreover, the shelves 404 may have magnetic properties to facilitate retaining tools with magnetic properties. Also, the shelves 404 may include an optional ledge to facilitate preventing the press frame tools from rolling or falling off the shelves 404. The tool storage system 400 facilitates preventing loss or misplacement of the press frame tools.

The housing 402 and the shelves 404 of the tool storage system 400 may be provided in the form of a metal, such as steel and/or aluminum, or any other suitable material, such as plastic, that provides durability and the strength to retain press frame tools therein.

Although described herein as one storage tool system 400 coupled to the frame 102, any number of suitable storage tool systems 400 may be coupled to the frame 102 and further the one or more storage tool systems 400 may be coupled to the frame 102 at any suitable location.

To prepare for operation of the press frame 100, at least one end 302 of the workpiece 300 is positioned between the hydraulic ram 104 and the bed frame 106 such that the at least one first end of the workpiece 300 may be supported by the arbor plate 146 of the bed frame 106. The operator may then rotate at least one support arm 202 away from the upper cross member 112 to form the angle 213 between the support arm 202 and the channel 214 of the upper cross member 112. The angle 213 is determined based on the size and the shape of the workpiece. Once the angle is determined, the operator may lock the support arm 202 in place to prevent further rotation of the support arm 202. The operator may then position the coupler 204 at or near the attachment point 219 along the support arm 202, such that the position of the coupler 204 may be determined by the size and shape of the workpiece. Once the support arm 202 is positioned and the coupler 204 is positioned between the first end 203 and the second end 206 of the support arm 202, the operator may situate the other end 304 of the workpiece 300. For example, the operator may use the engager 218 of the workpiece support system 200 to engage the other end 304 of the workpiece 300 to secure and/or suspend the workpiece 300. Before and/or after coupling the coupler 204 to the workpiece 300, the operator may adjust the length 215 of the coupler 204. When the workpiece 300 is coupled to the coupler 204, the workpiece 300 is suspended and the operator may not have to hold or support the workpiece 300 during operation of the press frame 100.

Before and/or after suspending the workpiece 300 via the coupler 204, the operator may (e.g., optionally) adjust the height of the bed frame 106 with at least one of the gas struts 150 such that the bed frame 106 (e.g., vertically) slides within the channels of the uprights 110. The gas struts 150 may provide both small adjustments (e.g., 0 -50 millimeters of adjustment) and large adjustments (e.g., 3 inches-36 inches) in the height of the bed frame 106. Adjusting the height of the bed frame 106 provides additional stability of the workpiece 300.

Once the workpiece 300 is suspended, the coupler 204 has been adjusted, and/or the height of the bed frame 106 has been adjusted, the operator then may operate the press frame 100 (e.g., the hydraulic ram 104, the handle, etc.) to manipulate the workpiece 300 to (e.g., desired) specifications.

Additionally, before or after positioning the workpiece 300, the operator may easily change the press tools with press tools stored on the tool storage system 400.

The present disclosure describes various features and operations of the disclosed systems. The illustrative implementations described herein are not meant to be limiting. Certain aspects of the disclosed systems can be arranged and combined in a variety of different configurations, all of which are contemplated herein.

Further, unless context suggests otherwise, the features illustrated in each of the figures may be used separately or in combination. Thus, the figures should be generally viewed as component aspects of one or more overall implementations, with the understanding that not all illustrated features are necessary for each implementation.

While various aspects and implementations have been disclosed herein, other aspects and implementations will be apparent to those skilled in the art. The various aspects and implementations disclosed herein are for purposes of illustration and are not intended to be limiting. Also, the terminology used herein is for the purpose of describing particular implementations and is not intended to be limiting.

Implementations of the present disclosure can thus relate to one of the enumerated examples (EE) listed below.

EE 1 is a press frame for manipulating a workpiece, the press frame including a frame having a first upright and a second upright, a cross member extending between the first upright and the second upright, a bed frame positioned below the cross member, the bed frame extends between the first upright and the second upright, and a workpiece support system. The workpiece support system includes a support arm coupled to the frame and configured to rotate outward in a rotated position, and a coupler extending between the support arm and the workpiece, the coupler configured to engage the workpiece to facilitate suspending the workpiece.

EE 2 is the press frame of EE 1, further including a tool storage system coupled to the first upright or the second upright.

EE 3 is the press frame of EE 1 or EE 2, the tool storage system includes a housing and a plurality of shelves for retaining at least one press tool.

EE 4 is the press frame of EE 3, the housing of the tool storage system is configured to rotate with respect to the first upright or the second upright.

EE 5 is the press frame of any of EE 1 to EE 4, further including at least one adjuster coupled between the bed frame and at least one of the first upright or the second upright, and the at least one adjuster is configured to adjust a height of the bed frame within a first channel of the first upright and within a second channel of the second upright.

EE 6 is the press frame of EE 5, the at least one adjuster is a gas strut.

EE 7 is the press frame of any of EE 1 to EE 6, further including at least one engager coupled to the coupler, and the at least one engager is configured to engage at least one end of the workpiece.

EE 8 is the press frame of any of EE 1 to EE 7, the coupler is an adjustable strap.

EE 9 is the press frame of any of EE 1 to EE 8, the coupler is substantially parallel of the first upright and the second upright.

EE 10 is the press frame of any of EE 1 to EE 9, the coupler has a length substantially equal to a length provided between the cross member and the bed frame.

EE 11 is the press frame of any of EE 1 to EE 10, the support arm is a telescoping steel tube to facilitate adjusting a length of the support arm.

EE 12 is the press frame of any of EE 1 to EE 11, the support arm is coupled to the frame above the bed frame.

EE 13 is the press frame of any of EE 1 to EE 11, the support arm is coupled to the bed frame.

EE 14 is the press frame of any of EE 1 to EE 13, the support arm is substantially perpendicular to the first upright and the second upright, and the support arm is substantially parallel to the workpiece.

EE 15 is the press frame of any of EE 1 to EE 14, the support arm is substantially perpendicular to the coupler.

EE 16 is the press frame of any of EE 1 to EE 15, the support arm includes a flange to substantially prevent the coupler from sliding off the support arm.

EE 17 is the press frame of any of EE 1 to EE 16, when the support arm is in the rotated position, an acute angle is formed between the support arm and the cross member.

EE 18 is the press frame of any of EE 1 to EE 17, the press frame is a hydraulic press frame.

EE 19 is the press frame of any of EE 1 to EE 18, further including a bottle jack coupled to a base, and the base is coupled to the cross member.

EE 20 is the press frame of any of EE 1 to EE 19, the bottle jack includes at least one of a saddle or a ram, and the ram is facing downward towards the bed frame.

What is claimed:

1. A press frame for manipulating a workpiece, the press frame comprising:
a frame having a first upright and a second upright;
a cross member extending between the first upright and the second upright;
a bed frame positioned below the cross member, the bed frame extends between the first upright and the second upright; and
a workpiece support system including
a support arm coupled to the frame and configured to rotate outward in a rotated position, and
a coupler extending between the support arm and the workpiece, the coupler configured to engage the workpiece to facilitate suspending the workpiece.

2. The press frame of claim 1, further comprising a tool storage system coupled to the first upright or the second upright.

3. The press frame of claim 2, wherein the tool storage system includes a housing and a plurality of shelves for retaining at least one press tool.

4. The press frame of claim 3, wherein the housing of the tool storage system is configured to rotate with respect to the first upright or the second upright.

5. The press frame of claim 1, further comprises at least one adjuster coupled between the bed frame and at least one of the first upright or the second upright, wherein the at least one adjuster is configured to adjust a height of the bed frame within a first channel of the first upright and within a second channel of the second upright.

6. The press frame of claim 5, wherein the at least one adjuster is a gas strut.

7. The press frame of claim 1, further comprises at least one engager coupled to the coupler, wherein the at least one engager is configured to engage at least one end of the workpiece.

8. The press frame of claim 1, wherein the coupler is an adjustable strap.

9. The press frame of claim 1, wherein the coupler is substantially parallel of the first upright and the second upright.

10. The press frame of claim 1, wherein the coupler has a length substantially equal to a length provided between the cross member and the bed frame.

11. The press frame of claim 1, wherein the support arm is a telescoping steel tube to facilitate adjusting a length of the support arm.

12. The press frame of claim 1, wherein the support arm is coupled to the frame above the bed frame.

13. The press frame of claim 1, wherein the support arm is coupled to the bed frame.

14. The press frame of claim 1, wherein the support arm is substantially perpendicular to the first upright and the second upright, and the support arm is substantially parallel to the workpiece.

15. The press frame of claim 1, wherein the support arm is substantially perpendicular to the coupler.

16. The press frame of claim 1, wherein the support arm includes a flange to substantially prevent the coupler from sliding off the support arm.

17. The press frame of claim 1, wherein, when the support arm is in the rotated position, an acute angle is formed between the support arm and the cross member.

18. The press frame of claim 1, wherein the press frame is a hydraulic press frame.

19. The press frame of claim 1, further comprising a bottle jack coupled to a base, wherein the base is coupled to the cross member.

20. The press frame of claim 19, wherein the bottle jack includes at least one of a saddle or a ram, wherein the ram is facing downward towards the bed frame.
